(19) United States
(12) Patent Application Publication
(10) Pub. No.: US 2007/0076966 A1
(43) Pub. Date: Apr. 5, 2007

(54) Image forming system and method

(75) Inventor: Ho-Kuen Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/524,210

(22) Filed: Sep. 21, 2006

(30) Foreign Application Priority Data
Sep. 30, 2005 (KR) 2005-92136

(51) Int. Cl. G06K 9/36; G06F 3/12

(52) U.S. Cl. 382/239; 358/1.15

(57) ABSTRACT

An image forming system and method including: a host device which divides data to be printed based on color or attribute and compresses the data using separate compression methods according to the division result; and an image forming apparatus which decompresses the compressed data in accordance to the compression method and prints the data. Accordingly, printing quality deterioration of an image data having high frequency stemming from a lossy compression can be prevented, a processing speed increases since compression efficiency increases, providing convenience in use, and a production cost decreases since the image forming apparatus does no longer require a storage medium of large capacity.

### CROSS-REFERENCE TO RELATED APPLICATION

This application claims the benefit of Korean Patent Application No. 2005-92136, filed on Sep. 30, 2005, in the Korean Intellectual Property Office, the disclosure of which is incorporated herein by reference.

### BACKGROUND OF THE INVENTION

1. Field of the Invention

Aspects of the present invention relate to an image forming system, and more particularly, to an image forming system and method in which a host device divides data to be printed into data portions based on color or attribute and compresses the data portions using separate compression methods, and an image forming apparatus decompresses the data in accordance with the compression methods and prints the data.

2. Description of the Related Art

Data compression methods are classified into a lossless compression method and a lossy compression method. In the lossless compression method, after decompressing compressed data, every bit of the data is the same as original data. Using the lossless compression method, a file size can be normally compressed by as much as 40% with respect to the original data. In the lossy compression method, the decompressed data differs from the original data. A permissible range of data loss in the lossy compression may vary based on certain conditions. In order to increase a compression rate, original data may be lost.

FIG. 1A is a view of original image data. FIG. 1B is a view illustrating a result of a lossless compression and decompression of the original image data. FIG. 1C is a view illustrating a result of a lossy compression and decompression of the original image data.

An image forming system prints data requiring eight bits to represent one pixel in a form of a one-bit binary image using screening or error diffusion methods. If the image forming system lossless-compresses data to be printed, as shown in FIG. 1B, the loss of original image data does not occur. However, since the size of the image data is substantially large, a processing speed decreases, causing inconvenience in use, and a production cost increases since a storage medium of large capacity must be provided in an image forming apparatus.

If the image forming system lossy-compresses the data to be printed, as shown in FIG. 1C, the size of the image data can be reduced. However, printing quality deteriorates due to the loss of image data in a compression process. An example of such as an image data loss in a portion of an image data having high frequency is shown in FIG. 1C.

### SUMMARY OF THE INVENTION

Aspects of the present invention provide an image forming system and method in which a host device divides data to be printed into data portions based on color or attribute, the data is compressed using separate compression methods, and an image forming apparatus decompresses the data in accordance with the compression methods, thereby printing the data in better quality.

According to an aspect of the present invention, there is provided an image forming system comprising: a host device to divide data to be printed into data portions based on color or attribute and compresses the data using separate compression methods according to the division result; and an image forming apparatus which decompresses the compressed data in accordance with the compression methods and prints the data.

The host device may, although not necessarily, comprise: a compression unit to divide the data to be printed into a first data portion and a second data portion based on color or attribute and lossless-compresses or lossy-compresses the data corresponding to the divided portion according to the division result; and a transmitting unit to transmit the compressed data to the image forming apparatus.

The compression unit may, although not necessarily, comprise: a data division unit to divide the data to be printed into the first data portion and the second data portion based on color or attribute; a lossless compression unit to losslessly-compress the data divided into the first data portion; and a lossy compression unit to lossy-compress the data divided into the second data portion.

The image forming apparatus may, although not necessarily, comprise: a receiving unit to receive the transmitted data; a decompression unit to decompress the received data in accordance with the data compression methods; and a printing unit to print the decompressed data.

The decompression unit may, although not necessarily, comprise: a lossless decompression unit to decompress the lossless-compressed data among the received data; a lossy decompression unit to decompress the lossy-compressed data among the received data; and a data composition unit to compose the data decompressed by the lossless decompression unit and the data decompressed by the lossy decompression unit.

The image forming apparatus may, although not necessarily, further comprise a storage unit to store the received data.

The image forming apparatus may, although not necessarily, further comprise a process unit detection unit to detect whether processing units of the lossless compression and the lossy compression with respect to the received data are equivalent and to output the detection result, wherein the storage unit stores the received data in response to the output result.

The image forming apparatus may, although not necessarily, further comprise a comparison unit to compare the number of lines of the received data with a predetermined critical value and to output the comparison result, wherein the storage unit stores the received data in response to the output result.

The first data portion may, although not necessarily, show whether the data to be printed corresponds to a white color, and in the second data portion, a color value corresponding to the first data portion may be modified to an initial color value.

The first data portion may, although not necessarily, show whether an initial color value of the data to be printed is greater than a predetermined color value, and in the second data portion, a color value corresponding to the first data portion may be modified to the initial color value.

The predetermined color value of the first data portion may, although not necessarily, be a critical color value of a visible white color.

The first data portion may, although not necessarily, be limited to whether having a white text attribute, and a black text portion is preferably added.

According to another aspect of the present invention, there is provided an image forming method comprising: dividing data to be printed into data portions based on color or attribute and compressing the data using separate compression methods according to the division result; transmitting the compressed data by a host device; receiving the transmitted data in an image forming apparatus; decompressing the received data in accordance with the compression methods; and printing the decompressed data.

The dividing may, although not necessarily, comprise: dividing the data to be printed into a first data portion and a second data portion based on color or attribute; lossless-compressing the data divided into the first data portion; and lossy-compressing the data divided into the second data portion.

The receiving may, although not necessarily, comprise: decompressing the lossless-compressed data among the received data; decompressing the lossy-compressed data among the received data; and composing the data decompressed in the lossless decompressing and the data decompressed in the lossy decompressing.

The image forming method may, although not necessarily, further comprise storing the received data.

The storing may, although not necessarily, comprise: detecting whether processing units of the lossless compression and the lossy compression, with respect to the received data, are equivalent; and storing the received data if determined to be different in detecting.

The storing may, although not necessarily, comprise: comparing the number of lines of the received data with a predetermined critical value; and storing the received data if the number of lines of the received data is greater than the predetermined critical value according to the comparison result.

The first data portion may, although not necessarily, show whether the data to be printed corresponds to a white color, and in the second data portion, a color value corresponding to the first data portion may be modified to an initial color value.

The first data portion may, although not necessarily, show whether the data to be printed is greater than a predetermined color value, and in the second data portion, a color value corresponding to the first data portion may be modified to an initial color value.

The predetermined color value of the first data portion may, although not necessarily, be a critical color value of a visible white color.

The first data portion may, although not necessarily, be limited to be a white portion having a text attribute, and a black portion having a text attribute may be added thereto.

According to yet another aspect of the present invention, there is provided a computer-readable medium encoded with the above-mentioned method and implemented by a computer.

Additional aspects and/or advantages of the invention will be set forth in part in the description which follows and, in part, will be obvious from the description, or may be learned by practice of the invention.

### BRIEF DESCRIPTION OF THE DRAWINGS

The patent or application file contains at least one drawing executed in color. Copies of this patent or patent application publication with color drawings will be provided by the U.S. Patent and Trademark Office upon request and payment of the necessary fee. These and/or other aspects and advantages of the invention will become apparent and more readily appreciated from the following description of the embodiments, taken in conjunction with the accompanying drawings of which:

FIG. 1A is a view of original image data;

FIG. 1B is a view illustrating a result of a lossless compression and decompression of the original image data;

FIG. 1C is a view illustrating a result of a lossy compression and decompression of the original image data;

FIG. 2 is a block diagram of an image forming system according to an embodiment of the present invention;

FIG. 3 is a flowchart of an image forming method according to an embodiment of the present invention;

FIG. 4 is a flowchart of an image forming method according to an embodiment of the present invention; and

FIGS. 5A and 5B are reference views illustrating an image forming apparatus of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

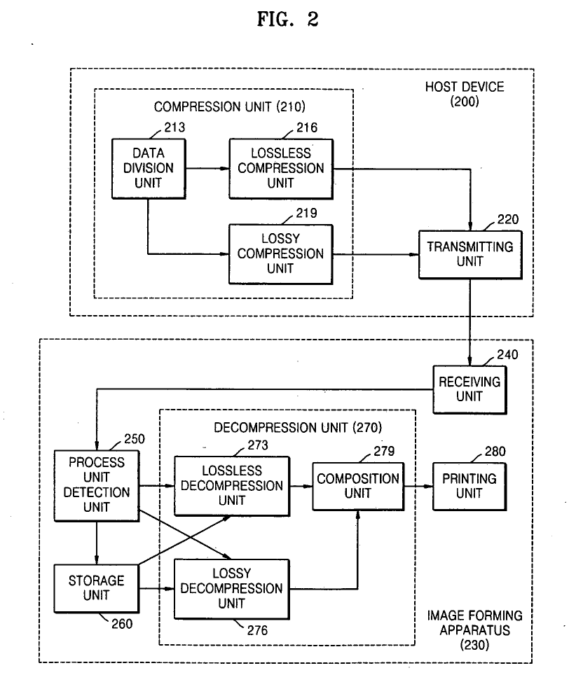

FIG. 2 is a block diagram of an image forming system according to an embodiment of the present invention. The image forming system includes a host device 200 and an image forming apparatus 230.

The host device 200 includes a compression unit 210 and a transmitting unit 220.

The compression unit 210 divides data to be printed into data portions based on color or attribute. Then, the compression unit 210 compresses the data corresponding to respective divided data portions using separate compression methods, according to the division result, that can minimize a data loss, such as a lossless compression method or a lossy compression method.

The compression unit 210 includes a data division unit 213, a lossless compression unit 216, and a lossy compression unit 219.

The data division unit 213 divides the data to be printed into a first data portion and a second data portion based on color or attribute.

The first data portion may, although not necessarily, show whether the data to be printed corresponds to a white color; for example, whether an RGB value corresponds to (255, 255, 255). Alternately, the first data portion may, although not necessarily, show whether a color value of the data to be printed is greater than a predetermined color value. In the present embodiment, the predetermined color value is a minimum color value of a visible white color. In addition, the first data portion may be limited to be a white portion having a text attribute, and a black portion having a text attribute may be added thereto.

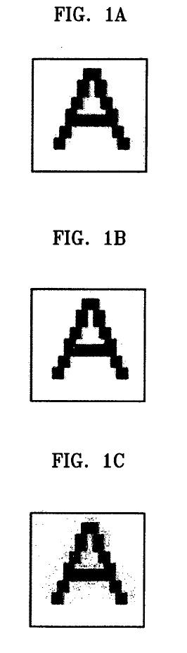

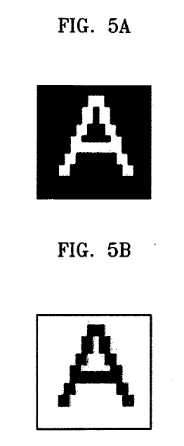

In the second data portion, color values corresponding to the first data portion are modified to an initial color value. It is understood that the initial color value is the color value of the original data, before the original data is divided into the first data portion and the second data portion. For example, if original data shown in FIG. 1A is transmitted to the image forming apparatus 230, the data division unit 213 divides the data into the first data portion, which shows whether the data corresponds to a white color as shown in FIG. 5A, and the second data portion, in which a white portion in the first data portion is filled with an initial color value and a black portion in the first data portion is modified to white. The first data portion is shown in FIG. 5A, and the second data portion is shown in FIG. 1A.

The lossless compression unit 216 lossless-compresses the data that is divided into the first data portion by the data division unit 213. As shown in FIG. 5A, the lossless compression unit 216 lossless-compresses the data shown as black which is the first data portion.

The lossy compression unit 219 lossy-compresses the data that is divided into the second data portion by the data division unit 213. Here, the lossy compression unit 219 lossy-compresses the original data of FIG. 1A.

The transmitting unit 220 transmits the data compressed by the lossless compression unit 216 and the data compressed by the lossy compression unit 219 to a receiving unit 240 in the image forming apparatus 230.

The image forming apparatus 230 includes the receiving unit 240, a process unit detection unit 250, a storage unit 260, a decompression unit 270, a lossless decompression unit 273, a lossy decompression unit 276, a composition unit 279, and a printing unit 280. However, it is understood that less or other units may be used to satisfy the aspects of the present invention.

The receiving unit 240 receives the data transmitted from the transmitting unit 220 in the host device 200.

The process unit detection unit 250 may, although not necessarily, analyze the data received from the receiving unit 240, determine whether processing units of the lossless compression and the lossy compression are equivalent, and output the determination result. It is understood that other units, methods, and/or devices may be used to analyze the data received from the receiving unit 240. For example, rather than the process unit detection unit 250, the image forming apparatus 230 may, although not necessarily, include a comparison unit (not shown), wherein the number of lines of data received from the receiving unit 240 is compared to a predetermined critical value, and a comparison result is outputted. “Processing units,” as the term is used here, are meant to the number of lines of the first compression method and that for the second method.

The storage unit 260 stores the data received from the receiving unit 240 if, according to one aspect of the present invention, the processing unit detection unit 250 determines that the processing units of the lossless compression and the lossy compression are different, or, according to another aspect of the present invention, the comparison unit (not shown) determines that the number of lines of the data received from the receiving unit 240 is greater than the predetermined critical value. The predetermined critical value is a maximum data size that can be processed in the decompression unit 270 without being stored in the storage unit 260.

The decompression unit 270 obtains the data received from the receiving unit 240 or extracts the data from the storage unit 260 so as to decompress the data in accordance with the data compression method. The decompression unit 270 includes the lossless decompression unit 273, the lossy compression decompression unit 276, and the composition unit 279.

The lossless decompression unit 273 obtains the data received from the receiving unit 240 or extracts the data from the storage unit 260 so as to decompress the lossless-compressed data.

The lossy compression decompression unit 276 obtains the data received from the receiving unit 240 or extracts the data from the storage unit 260 so as to decompress the lossy-compressed data.

The composition unit 279 composes the data decompressed by the lossless decompression unit 273 and the data decompressed by the lossy compression decompression unit 276. The printing unit 280 prints the data composed by the composition unit 279.

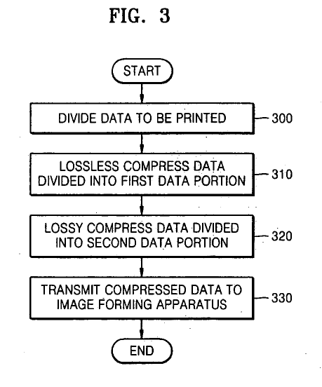

FIG. 3 is a flowchart of an image forming method according to an embodiment of the present invention.

Referring to FIG. 3, image data to be printed is first divided into a first data portion and a second data portion based on color or attribute (operation 300). It is understood that image data is any data transmitted to be printed. The first data portion may, although not necessarily, show whether the data to be printed corresponds to a white color; for example, whether an RGB value corresponds to (255, 255, 255). Alternately, the first data portion may, although not necessarily, show whether a color value of the data to be printed is greater than a predetermined color value. Here, the predetermined color value is a minimum color value of a visible white color.

In the second data portion, the first data portion of the data to be printed is modified to an initial color value.

The data of the first data portion is lossless-compressed (operation 310). The data of the second data portion is lossy-compressed (operation 320). The lossless-compressed data of operation 310 and the lossy-compressed data of operation 320 are transmitted to the image forming apparatus (operation 330).

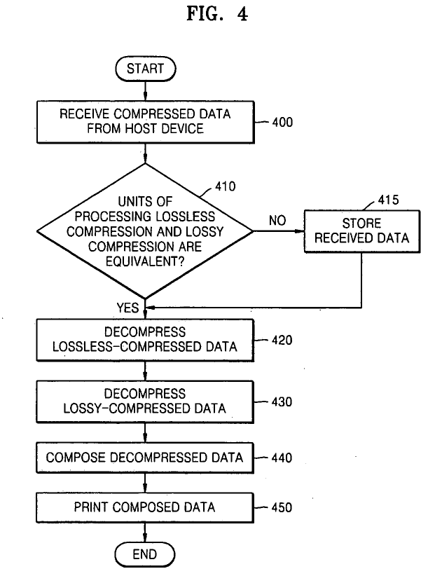

FIG. 4 is a flowchart of an image forming method according to an embodiment of the present invention.

Referring to FIG. 4, the compressed data is first received from the host device (operation 400).

The data received in operation 400 is analyzed and, according to one aspect of the present invention, determined whether the processing units of the lossless compression and the lossy compression are equivalent (operation 410).

According to another aspect of the present invention, operation 410 can be replaced with comparing the size of data received in operation 400 with a predetermined critical value.

If it is determined, according to one aspect of the present invention, that the units of processing the lossless compression and the lossy compression are different, or, according to another aspect of the present invention, the size of data received in operation 400 is greater than the predetermined critical value in operation 410, the data received in operation 400 is stored (operation 415). The predetermined critical value is a maximum data size that can be processed without being stored in a storage medium.

The data received in operation 400 is obtained or the data stored in operation 415 is extracted to decompress the lossless-compressed data (operation 420). The data received in operation 400 is obtained or the data stored in operation 415 is extracted to decompress the lossy-compressed data (operation 430). Operations 420 and 430 may be performed in reverse order or concurrently.

The data decompressed in operation 420 and the data decompressed in operation 430 are composed (operation 440and printed (operation 450).

Accordingly, the present invention provides an image forming system and method, wherein a host device divides data to be printed into data portions based on color or attribute, the data is compressed using separate compression methods, and an image forming apparatus decompresses the data in accordance with the compression methods and prints the data.

Therefore, printing quality deterioration of an image data having high frequency stemming from a lossy compression can be prevented. Furthermore, a processing speed increases since compression efficiency increases, providing convenience in use, and a production cost decreases since the image forming apparatus no longer requires a storage medium of large capacity.

The embodiments of the present invention can be written as computer-readable codes on a computer-readable medium. The computer includes any device having information-processing capabilities. The computer-readable recording medium is any data storage device that can store data that can be thereafter read by a computer system. Examples of the computer-readable recording medium include, but are not limited to, read-only memory (ROM), random-access memory (RAM), CD-ROMS, magnetic tapes, floppy disks, and optical data storage devices.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming system comprising:
a host device to divide data to be printed into data portions, to compress the divided data using separate compression methods according to the divided data, and to transmit the compressed data; and
an image forming apparatus to receive the compressed data, to decompress the compressed data in accordance with the compression methods, and to print the data.

2. The image forming system as claimed in claim 1, wherein the host device comprises:
a compression unit to divide the data to be printed into a first data portion and a second data portion based on initial color values or attributes, wherein the first data portion is compressed with a first compression method and the second data portion is compressed with a second compression method; and
a transmitting unit to transmit the compressed data to the image forming apparatus.

3. The image forming system as claimed in claim 2, wherein the compression unit comprises:
a data division unit to divide the data to be printed into the first data portion and the second data portion based on the initial color values or attributes;
a first compression method compression unit to compress the data divided into the first data portion with the first compression method; and
a second compression method compression unit to compress the data divided into the second data portion with the second compression method.

4. The image forming system as claimed in claim 3, wherein the first compression method is a lossless compression method, the second compression method is a lossy compression method, the first compression method compression unit is a lossless compression unit, and the second compression method compression unit is a lossy compression unit.

5. The image forming system as claimed in claim 1, wherein the image forming apparatus comprises:
a receiving unit to receive the transmitted data;
a decompression unit to decompress the received data in accordance with the compression methods; and
a printing unit to print the decompressed data.

6. The image forming system as claimed in claim 5, wherein the decompression unit comprises:
a first compression method decompression unit to decompress a first data, compressed in a first compression method, among the received data;
a second compression method decompression unit to decompresses a second data, compressed in a second compression method, among the received data; and
a data composition unit to compose the first data, decompressed by the first compression method decompression unit, and the second data, decompressed by the second compression method decompression unit.

7. The image forming system as claimed in claim 6, wherein the first compression method is a lossless compression method, the second compression method is a lossy compression method, the first compression method decompression unit is a lossless decompression unit, and the second compression method decompression unit is a lossy decompression unit.

8. The image forming system as claimed in claim 6, wherein the image forming apparatus further comprises a storage unit to store the received data.

9. The image forming system as claimed in claim 8, wherein the image forming apparatus further comprises:
processing units of the first compression method and the second compression method; and
a process unit detection unit to detect whether the processing units of the first compression method and the second compression method, with respect to the received data, are equivalent and to output a detection result, wherein
when the detection result indicates that the processing units are not equivalent, the storage unit stores the received data.

10. The image forming system as claimed in claim 8, wherein the image forming apparatus further comprises:
a comparison unit to compare a size of the received data with a predetermined critical value and to output a comparison result, wherein
when the size of the received data is greater than the predetermined critical value, the storage unit stores the received data.

11. The image forming system as claimed in claim 2, wherein the first data portion shows whether the initial color values of the data to be printed correspond to a white color.

12. The image forming system as claimed in claim 11, wherein, in the second data portion, color values corresponding to the first data portion are modified to the initial color values.

13. The image forming system as claimed in claim 2, wherein the first data portion shows whether the initial color values of the data to be printed are greater than a predetermined color value.

14. The image forming system as claimed in claim 13, wherein, in the second data portion, color values corresponding to the first data portion are modified to the initial color values.

15. The image forming system as claimed in claim 13, wherein the predetermined color value of the first data portion is a critical color value of a visible white color.

16. The image forming system as claimed in claim 2, wherein the first data portion shows whether the data to be printed corresponds to a black text.

17. The image forming system as claimed in claim 16, wherein, in the second data portion, color values corresponding to the first data portion are modified to the initial color values.

18. The image forming system as claimed in claim 2, wherein the image forming apparatus comprises:
a receiving unit to receive the transmitted data;
a decompression unit to decompress the received data in accordance with the compression methods; and
a printing unit to print the decompressed data.

19. An image data transfer method of an image forming system including a host device and an image forming apparatus, the data transfer method comprising:
dividing data to be printed into data portions and compressing the divided data using separate compression methods according to the dividing of the data;
transmitting the compressed data by the host device;
receiving the transmitted data in the image forming apparatus;
decompressing the received data in accordance with the compression methods; and
printing the decompressed data.

20. The image data transfer method as claimed in claim 19, wherein the dividing of the data to be printed comprises:
dividing the data to be printed into a first data portion and a second data portion based on initial color values or attributes;
compressing the data divided into the first data portion with a first compression method; and
compressing the data divided into the second data portion with a second compression method.

21. The image data transfer method as claimed in claim 20, wherein the first compression method is a lossless compression, and the second compression method is a lossy compression.

22. The image data transfer method as claimed in claim 19, wherein the decompressing of the received data comprises:
decompressing a first data, compressed with a first compression method, among the received data;
decompressing a second data, compressed with a second compression method, among the received data; and
composing the decompressed first data and the decompressed second data.

23. The image data transfer method as claimed in claim 22, wherein the first compression method is a lossless compression, and the second compression method is a lossy compression.

24. The image data transfer method as claimed in claim 19, further comprising storing the received data.

25. The image data transfer method as claimed in claim 24, wherein the storing of the received data comprises:
detecting whether processing units of a first compression method and a second compression method, with respect to the received data, are equivalent; and
storing the received data when the processing units of the first compression method and the second compression method are not equivalent.

26. The image data transfer method as claimed in claim 24, wherein the storing comprises:
comparing a size of the received data with a predetermined critical value; and
storing the received data when the size of the received data is greater than the predetermined critical value.

27. The image data transfer method as claimed in claim 20, wherein the first data portion shows whether the initial color values of the data to be printed correspond to a white color.

28. The image data transfer method as claimed in claim 27, wherein, in the second data portion, color values corresponding to the first data portion are modified to the initial color values.

29. The image data transfer method as claimed in claim 20, wherein the first data portion shows whether the initial color values of the data to be printed are greater than a predetermined color value.

30. The image data transfer method as claimed in claim 29, wherein, in the second data portion, color values corresponding to the first data portion are modified to the initial color values.

31. The image data transfer method as claimed in claim 29, wherein the predetermined color value of the first data portion is a critical color value of a visible white color.

32. The image data transfer method as claimed in claim 20, wherein the first data portion shows whether the data to be printed corresponds to a black text.

33. The image data transfer method as claimed in claim 32, wherein, in the second data portion, color values corresponding to the first data portion are modified to the initial color values.

34. A computer-readable medium encoded with the method of claim 19 implemented by a computer.

35. A host device to divide, compress with a plurality of methods, and output data to be printed, the host device comprising:
a compression unit to divide the data to be printed into a first data portion and a second data portion based on initial color values or attributes, wherein the first data portion is compressed with a first compression method and the second data portion is compressed with a second compression method; and
a transmitting unit to output the compressed data to an image forming apparatus.

36. The host device as claimed in claim 35, wherein the compression unit comprises:
a data division unit to divide the data to be printed into the first data portion and the second data portion based on the initial color values or attributes;
a first compression method compression unit to compress the data divided into the first data portion with the first compression method; and
a second compression method compression unit to compress the data divided into the second data portion with the second compression method.

37. The host device as claimed in claim 36, wherein the first compression method is a lossless compression method, the second compression method is a lossy compression method, the first compression method compression unit is a lossless compression unit, and the second compression method compression unit is a lossy compression unit.

38. The host device as claimed in claim 35, wherein the first data portion shows whether the initial color values of the data to be printed correspond to a white color.

39. The host device as claimed in claim 38, wherein, in the second data portion, color values corresponding to the first data portion are modified to the initial color values.

40. The host device as claimed in claim 35, wherein the first data portion shows whether the initial color values of the data to be printed are greater than a predetermined color value.

41. The host device as claimed in claim 40, wherein, in the second data portion, color values corresponding to the first data portion are modified to the initial color values.

42. The host device as claimed in claim 40, wherein the predetermined color value of the first data portion is a critical color value of a visible white color.

43. The host device as claimed in claim 35, wherein the first data portion shows whether the data to be printed corresponds to a black text.

44. The host device as claimed in claim 43, wherein, in the second data portion, color values corresponding to the first data portion are modified to the initial color values.

45. An image forming apparatus to receive and print data that is compressed with a plurality of compression methods, the image forming apparatus comprising:
a first compression method decompression unit to decompress a first data, compressed in a first compression method, among the received data;
a second compression method decompression unit to decompresses a second data, compressed in a second compression method, among the received data; and
a data composition unit to compose the first data, decompressed by the first compression method decompression unit, and the second data, decompressed by the second compression method decompression unit, wherein
the image forming apparatus prints the composed data.

46. The image forming apparatus as claimed in claim 45, wherein the first compression method is a lossless compression method, the second compression method is a lossy compression method, the first compression method decompression unit is a lossless decompression unit, and the second compression method decompression unit is a lossy decompression unit.

47. The image forming apparatus as claimed in claim 45, further comprising a storage unit to store the received data.

48. The image forming apparatus as claimed in claim 47, further comprising:
processing units of the first compression method and the second compression method; and
a process unit detection unit to detect whether the processing units of the first compression method and the second compression method, with respect to the received data, are equivalent and to output a detection result, wherein
when the detection result indicates that the processing units are not equivalent, the storage unit stores the received data.

49. The image forming apparatus as claimed in claim 47, further comprising:
a comparison unit to compare a size of the received data with a predetermined critical value and to output a comparison result, wherein
when the size of the received data is greater than the predetermined critical value, the storage unit stores the received data.
